(19) United States
(12) Patent Application Publication
(10) Pub. No.: US 2009/0257104 A1
(43) Pub. Date: Oct. 15, 2009

(54) Hologram Viewing Arrangement and Alignment Device

(76) Inventors: Adrian James Cable, Cambridgeshire (GB); Edward Buckley, Cambridge (GB); Nicholas Alexander Lawrence, Cambridge (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/086,552

(22) PCT Filed: Dec. 12, 2006
(86) PCT No.: PCT/GB2006/050448

§ 371 Date: Jan. 22, 2009

(30) Foreign Application Priority Data
Dec. 13, 2005 (GB) 0525336.4

(51) Int. Cl. G03H 1/08; G01B 11/14

(52) U.S. Cl. 359/9; 356/615

(57) ABSTRACT

The present invention relates to a hologram viewing arrangement, to an alignment device, to a display device, to a device for aligning first and second members and to a device for aligning an optical beam with a desired target. A hologram viewing arrangement comprising a pixellated phase mask substrate (20) and a pixellated hologram display substrate (40), wherein the hologram display substrate is arranged to store data representing at least two distinct images (3a-3d), the arrangement being such that disposing the phase mask in a first position with respect to the display substrate enables one of the at least two images to be visible and disposing the phase mask in a second position with respect to the display substrate enables another of the at least two images to be visible.

The present invention relates to a hologram viewing arrangement, to an alignment device, to a display device, to a device for aligning first and second members and to a device for aligning an optical beam with a desired target.

In our co-pending patent applications nos, WO2005/059660 and WO2005/059659 (both hereby incorporated by reference) it has been shown that a binary-phase hologram and a four-level random phase mask can be employed together with a suitable hologram-forming algorithm to efficiently and accurately form a wide-angle replay field (RPF) free of the normal conjugate image. An advantageous family of algorithms, known herein as OSPR, has also been disclosed in these patent applications.

One of the patent applications discusses how the technique is used in 2D and 3D video projection systems where commercial success depends on high image quality, high efficiency and low cost.

The invention is set out in the independent claims.

We describe a hologram viewing arrangement comprising a pixellated phase mask substrate and a pixellated hologram display substrate, wherein the hologram display substrate is arranged to store data representing at least two preferably distinct images, wherein the pixellation axes of the two members are disposed mutually parallel and wherein one of the phase mask substrate and hologram display substrate is constructed and arranged to be subject to a translation with respect to the other of the two substrates parallel to a pixellation axis thereof, the translation being between a first position in which (preferably only) one of the at least two distinct images is visible and a second position in which (preferably only) another of the at least two images is visible.

This may be achieved by compositing together two images into a single hologram.

In an embodiment, the pixels of the phase mask substrate have substantially identical dimensions to the pixels of the hologram display substrate.

In an embodiment, the phase mask is a two level phase mask.

In an embodiment constructed and arranged to operate at a given optical wavelength, with one of the levels of the phase mask as reference, the other level provides a phase shift of substantially n to light at the given optical wavelength.

In an embodiment, the phase mask is a four level phase mask.

In an embodiment, constructed and arranged to operate at a given optical wavelength, taking one of the four phase mask levels as a reference, the remaining three provide phase shifts of respectively π/2, π and 3π/2 to light at the given optical wavelength.

In an embodiment, the hologram display substrate is arranged to display binary holograms.

In an embodiment, the phase mask has an equal number of mask pixels at each level.

In an embodiment, the phase mask is random.

According to an aspect of the invention there is also provided an alignment device comprising a hologram viewing arrangement according to an aspect of the invention.

According to another aspect of the invention there is provided a display device comprising a hologram viewing arrangement according to an aspect of the invention.

According to a further aspect of the invention there is provided a device for aligning first and second members comprising a hologram viewing arrangement according to an aspect of the invention, wherein one of the pixellated phase mask substrate and the pixellated hologram display substrate is secured to the first member and the other of the pixellated phase mask substrate and the pixellated hologram display substrate is secured top the second member.

According to a still further aspect of the invention there is provided a device for aligning an optical beam with a desired target comprising a hologram viewing arrangement according to an aspect of the invention, wherein one of the pixellated phase mask substrate and the pixellated hologram display substrate is disposed to receive the said optical beam, and the hologram composites together plural phase images each capable of deflecting an incident beam by a different angle, the device having means for translating the other of the pixellated phase mask substrate and the pixellated hologram display substrate with respect to the one of the pixellated phase mask substrate and the pixellated hologram display substrate so that an image is displayed such as to align the optical beam with the said target.

There is also provided a measuring device in which successive regular displacements result in the display of a sequence of symbols such as numbers indicating measurements corresponding to the respective displacements.

Exemplary embodiments of the invention will now be described with reference to the accompanying drawings in which:

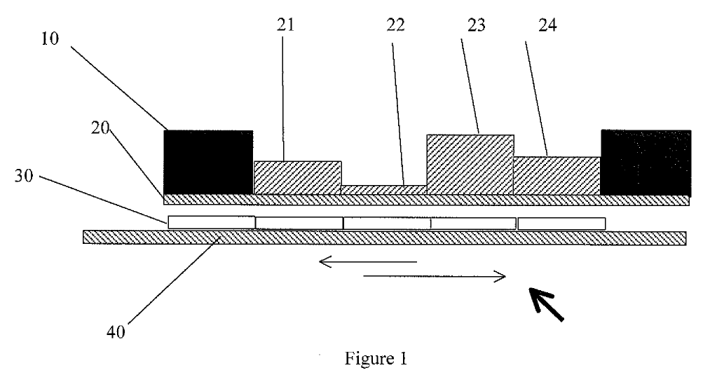

FIG. 1 shows a cross sectional view through an illustrative hologram viewing arrangement embodying the present invention;

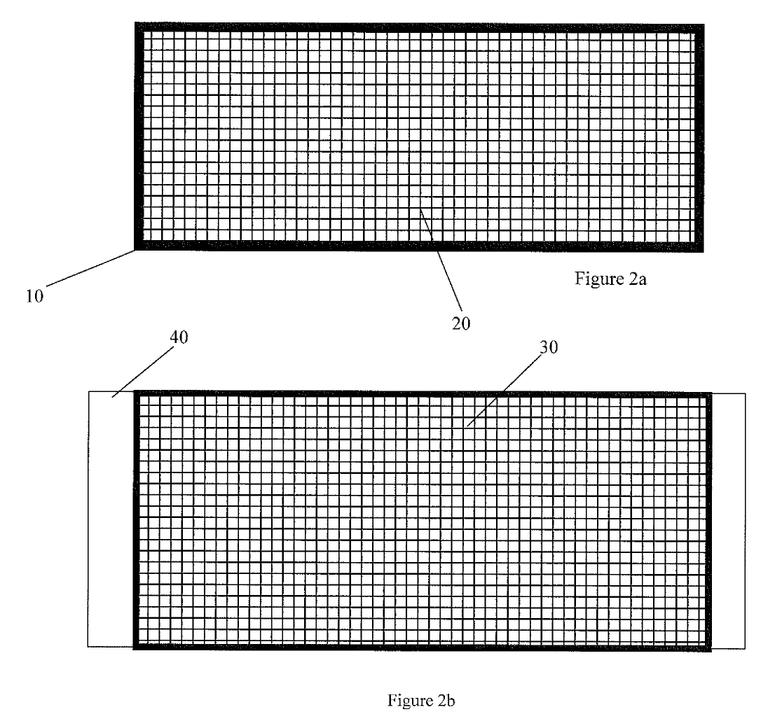

FIG. 2 shows a plan view of the components of a hologram viewing arrangement similar to FIG. 1;

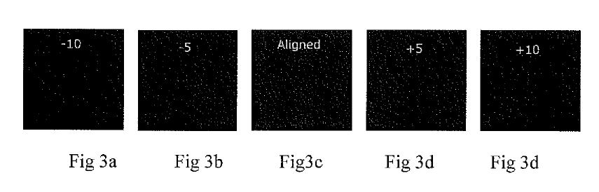

FIG. 3 shows illustrative holograms recorded on the hologram-bearing device of the arrangement of FIG. 2; and

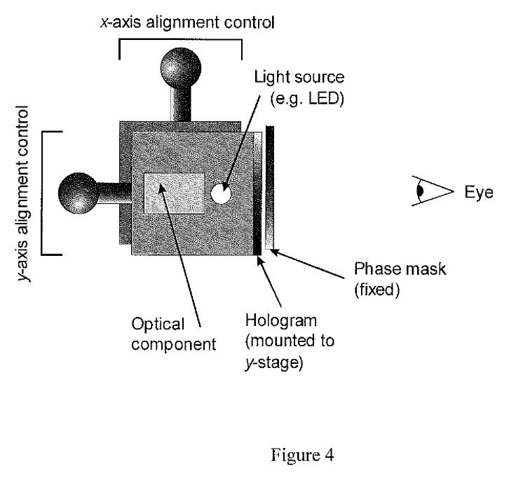

FIG. 4 shows a visual alignment system for an optical stage incorporating a hologram viewing arrangement embodying the present invention.

Referring to FIG. 1 a hologram viewing device (1) has a pixellated phase mask substrate (20) carrying a phase mask having plural pixels (21-24) and engaging a surrounding framework (10). A hologram supporting substrate (40) carries a pixellated hologram structure (30) such that the pixellated hologram (30) and the substrate (40) are translatable relative to the phase mask on its substrate (20).

Referring to FIGS. 2a and 2b, the two parts of the hologram viewing arrangement are shown separately. In FIG. 2a the phase mask substrate (20) is shown to be a two-dimensional array of pixels supported and surrounded by the frame (10). The hologram substrate (40) carries a two-dimensional array of hologram pixels (30).

It will be clear to those skilled in the art that depending upon the application many techniques are available for allowing the mutual translation between the hologram substrate (40) and the phase mask substrate (20).

For example each of these can be secured to a different part of a machine or device, for example where alignment between the two machine or device parts is sought. Alternatively, and as will be described below, where the device forms a display the two elements (20) and (40) may be mounted in a plastic holder, with a slot permitting movement of one with respect to the other.

In use the device is viewed with the phase mask disposed over the hologram. The light used for viewing the hologram may be monochromatic—e.g. using an LED, or alternatively by suitable modifications (for example reducing pixel size) white light viewing can be employed.

A hologram is calculated using a modified OSPR algorithm to take into account the phase mask distribution, the hologram compositing together two or more images. The hologram data are then recorded onto the pixellated substrate (30). When a hologram is perfectly aligned with the mask (20) and illuminated with coherent (laser) or semi-coherent (LED) light, one of the images is reproduced—yet when the hologram is misaligned with the mask in either the x- or y-directions the other, or respectively another, image is reproduced.

In another embodiment, the set of holograms is such that different misalignments enable reproduction of different independent images. In yet another embodiment, each image is the same at least for a set of alignments.

Preferably (but not essentially) the images are distinct. Preferably (but not essentially) in each position of the phase mask with respect to the hologram (display substrate) only one image is visible. (For example, in a measurement system the display could incrementally add an image, or retain a previous image, at a measurement position, eg. “1”, “1 2”, “1 2 3” or “1”, “1 2”, “2 3”).

FIG. 3 shows suitable hologram views useful as part of a measurement technique, using a 512×512-pixel binary hologram with 5 μm pixel size and a four-level random phase mask of corresponding dimensions. When the hologram is aligned with the phase mask, the RPF formed displays the ‘aligned’ image (FIG. 3c). However, a lateral shift of the hologram relative to the phase mask by one pixel, corresponding to a 5 μm shift to the left, produces the ‘−5’ image (FIG. 3b). A relative lateral shift of two pixels (or 10 μm) to the left produces the ‘−10’ image (FIG. 3a), and so on. Since the phase mask is random, the intensity isolation between each of the images is high—of the order of 20 dB, or 100 times—allowing completely independent image structure to be generated for very small misalignments.

Employing a hologram and phase mask in this manner allows embodiments to be created which allow μm-accurate measurements. Embodiments may be devoid of electronics, with automatic visual feedback supplied via the RPF.

Where the OSPR algorithm is used to generate the holograms, the RPF is of high quality. Alternative embodiments may thus be easily detectable by a CCD array, allowing measurement control by computer if required.

Although dynamic, reconfigurable spatial light modulators (SLMs) may be used to display the hologram patterns in some embodiments, in many embodiments the holograms do not have to change with time. Hence these embodiments can be cost-effective due to the lack of electronics and the simplicity of manufacturing volume quantities of the hologram and phase mask, which can both be fabricated in a straightforward manner in plastic or glass.

Referring to FIG. 4 one application is in alignment systems for optical stages. Most conventional methods involve interferometry and computationally-intensive computer control which are both expensive and complex. Embodiments of the invention can allow the x and y stage alignment to be immediately read from the RPF formed by the hologram and phase mask—the user simply sees a number corresponding to the misalignment in microns—dramatically reducing the complexity of the process. The visual feedback allows rapid and accurate adjustment, as desired.

Other instances occur in industrial processes where the accurate alignment of two objects represents a crucial step in the successful manufacture of a product, or where μm-accurate measurements are necessary. Embodiments of the invention may be applied to these situations.

In a second class of embodiments, the hologram sets depict different images, or images of different aspects of an entity. Since a different RPF image can be formed for each possible x- and y-axis misalignment between hologram and phase mask, the movement of the phase mask relative the hologram displaying substrate allow the different images or aspects to be viewed one at a time.

In one set of embodiments the holograms depict a scene at different angles corresponding to the amount of misalignment between hologram and phase mask, by comparison with a central position arbitrarily termed “aligned”. In some embodiments a device shows a 2D or 3D mock-up of a product, with the image changing as the user moves the mask relative to the hologram. Such a device could be used for promotional purposes and embodiments may be cheap to produce.

For example, one embodiment shows a 3D hologram of a car. The device has horizontal and vertical slider controls to move the hologram but not the phase mask. In one example, moving the horizontal slider for example causes the doors of the car to open and close, whereas moving the vertical slider causes zoom in and out. Such devices could be mass produced at very low cost, for example pence per device, since no electronics is required, and thus represent a very valuable marketing tool that is unlike anything currently available.

The described embodiments operate using four-level pixellated phase masks as they are straightforward to manufacture and work with in a computational sense, but the technique is also applicable to more general cases of multilevel phase masks, non-pixellated phase masks.

For the sake of completeness two examples of the one-step phase-retrieval (OSPR) algorithm are now given. The first example utilises a modified algorithm which begins with the specification of K target images T_{xy} [symbol] k [symbol] such that the replay field formed when the phase mask and hologram are displaced by k pixels in the x-direction approximates T_{xy} [symbol] k [symbol] and proceeds as follows:

Let T_{xy}⁽ⁿ⁾

[symbol]

k [symbol] =\sqrt{T_{xy} [symbol] k [symbol]}exp(jΦ_{xy}⁽ⁿ⁾) where Φ_{xy}⁽ⁿ⁾ is uniformly distributed between 0 and 2π for 1≦n≦N, 1≦x,y≦m, 0≦k≦K−1

Let

$${G}_{xy}^{( n )} = {\sum }_{k = 0}^{K - 1} \frac{ [ {T}_{xy}^{( n )} 〈 k 〉 ]}{{P}_{x + k - 1 , y}}$$

where [symbol] represents the 2D inverse Fourier transform operator, and P_{xy} is the phase mask, generated randomly so that each pixel has an equal probability of taking the value 1 or j.

Let R be the smallest positive real such that |G_{xy}⁽ⁿ⁾|≦R ∀x,y,n. We know that R will exist since each value taken by G_{xy}⁽ⁿ⁾ is finite and so G_{xy}⁽ⁿ⁾ has compact support

Let M_{xy}⁽ⁿ⁾=|α+G_{xy}⁽ⁿ⁾|, where α is real and very much greater than R

Let

$${H}_{xy}^{( n )} = \{ \begin{matrix}- 1 & if {M}_{xy}^{( n )} < {Q}^{( n )} \\ 1 & if {M}_{xy}^{( n )} \geq {Q}^{( n )}\end{matrix}$$

where Q⁽ⁿ⁾=median(M_{xy}⁽ⁿ⁾)

Step 1 forms N targets T_{xy}⁽ⁿ⁾ equal to the amplitude of the supplied intensity target T_{xy}, but with i.i.d. uniformly-random phase. Steps 2 and 3 shift the inverse Fourier transform holograms G_{xy}⁽ⁿ⁾ by a large distance to the right in the complex plane. This has the effect of making the phase of each point in the holograms very small, so that when in step 4 we take their magnitude M_{xy}⁽ⁿ⁾ (forcing the phase of every point to zero) we introduce practically no error. Binarisation of the hologram is then performed in step 5: thresholding around the median of M_{xy}⁽ⁿ⁾ ensures equal numbers of −1 and 1 points are present in the holograms, achieving DC balance (by definition) and also minimal reconstruction error.

For a 3D hologram, consider a plane, perpendicular to the z-axis, intersecting the origin, and one point source emitter of wavelength λ and amplitude A at position (X, Y, Z) behind it. The field F present at position (x, y) on the plane—i.e. the hologram—is given by

$$F ( x , y ) = \frac{ZA}{j λ {r}^{2}} exp ( \frac{2 π j }{λ} r ) \\ with \\ r = \sqrt{{( x - X )}^{2} + {( y - Y )}^{2} + {Z}^{2}} \qquad ( 8 )$$

If we regard a 3D scene as M sources of amplitude Aᵢ at (Xᵢ, Yᵢ, Zᵢ), the linear nature of EM propagation results in the total field hologram F being

$$F ( x , y ) = {\sum }_{i = 1}^{M} \frac{{Z}_{i} {A}_{i}}{j λ {r}_{i}^{2}} exp ( \frac{2 π j}{λ} {r}_{i} ) \\ with \\ {r}_{i} = \sqrt{{( x - {X}_{i} )}^{2} + {( y - {Y}_{i} )}^{2} + {Z}_{i}^{2}} \qquad ( 9 )$$

If we wish to sample F(x, y) over the region xₘᵢₙ≦x≦xₘₐₓ,yₘᵢₙ≦y≦yₘₐₓ to form an m×m hologram F_{xy}, we obtain:

$${F}_{xy} 〈 k 〉 = {\sum }_{i = 1}^{M} \frac{{Z}_{i} 〈 k 〉 {A}_{i} 〈 k 〉}{j λ {r}_{i} {〈 k 〉}^{2}} exp ( \frac{2 π j}{λ} {r}_{i} 〈 k 〉 )$$

$$with$$

$${r}_{i} 〈 k 〉 = \sqrt{\begin{matrix}\begin{matrix}{( {x}_{m i n} + x \frac{{x}_{ma x} - {x}_{m i n}}{m} - {X}_{i} 〈 k 〉 )}^{2} - \\ {( {y}_{m i n} + y \frac{ {y}_{ma x} - {y}_{m i n}}{m} - {Y}_{i} 〈 k 〉 )}^{2} +\end{matrix} \\ {Z}_{i} {〈 k 〉}^{2}\end{matrix}}$$

where here we have also considered the possibility of generating K distinct holograms for K distinct sets of points (where we define each distinct set of points as a scene) defined by Aᵢ<k>, Xᵢ<k>, Yᵢ<k>, Zᵢ<k>.

Thus a second modified version of OSPR (with an SLM phase mask) generates N full-parallax 3D holograms H_{xy}⁽ⁿ⁾, each compositing all of K scenes, such that the replay field formed when the phase mask and hologram are displaced by k pixels in the x-direction approximates the kth 3D scene defined by the points Aᵢ<k>, Xᵢ<k>, Yᵢ<k>, Zᵢ<k>:

1. Let

$${F}_{xy}^{( n )} 〈 k 〉 = {\sum }_{i = 1}^{M} \frac{{Z}_{i} 〈 k 〉 {A}_{i} 〈 k 〉}{j λ {r}_{i} {〈 k 〉}^{2}} exp ( {Φ}_{i}^{( n )} j + \frac{2 πj}{λ} {r}_{i} 〈 k 〉 )$$

with rᵢ<k> as above where Φᵢ⁽ⁿ⁾ is uniformly distributed between 0 and 2π for 1≦n≦N, 1≦i≦M, 0≦k≦K−1

2.

$$Let {G}_{xy}^{( n )} = {\sum }_{k = 0}^{K - 1} \frac{{F}_{xy}^{( n )} 〈 k 〉}{{P}_{x + k - 1 , y}} ,$$

where P_{xy} is the precomputed [1, j] phase mask as described in the previous section.

3. Let R be the smallest positive real such that |G_{xy}⁽ⁿ⁾|≦R ∀x, y, n. We know that R will exist since each value taken by G_{xy}⁽ⁿ⁾ is finite and so G_{x,y}⁽ⁿ⁾ has compact support

4. Let M_{xy}⁽ⁿ⁾=|α+G_{xy}⁽ⁿ⁾|, where α is real and very much greater than R

5. Let

$${H}_{xy}^{( n )} = \{ \begin{matrix}- 1 & if {M}_{xy}^{( n )} < {Q}^{( n )} \\ 1 & if {M}_{xy}^{( n )} \geq {Q}^{( n )}\end{matrix}$$

where Q⁽ⁿ⁾=median(M_{xy}⁽ⁿ⁾)

For a more complete discussion of the algorithm the reader should refer to our co-pending patent applications (ibid).

While the foregoing description refers to a new algorithm called herein OSPR this is only an example that may be advantageous in some situations. The invention in its broader aspects is not restricted to any particular algorithm and in embodiments, other algorithms may be used. Such algorithms include the direct binary search (DBS) and Gerchberg-Saxton (G-S) algorithms.

Although the above description relates to display of images where the image content differs among the displayed images, it would alternatively be possible to have identical or substantially identical images so that, for example, regardless of misalignment the same image is seen.

Various embodiments of the invention have now been described. The scope of the invention is not to be regarded as limited by the description but instead extends to the full scope of the appended claims.

1. A hologram viewing arrangement comprising a pixellated phase mask substrate and a pixellated hologram display substrate, wherein the hologram display substrate is arranged to store data representing at least two images, the arrangement being such that disposing the phase mask in a first position with respect to the display substrate enables one of the at least two images to be visible and disposing the phase mask in a second position with respect to the display substrate enables another of the at least two images to be visible.

2. A hologram viewing arrangement according to claim 1, wherein the pixellation axes of the two members are disposed mutually parallel and wherein one of the phase mask substrate and hologram display substrate is constructed and arranged to be subject to a translation with respect to the other of the two substrates parallel to a pixellation axis thereof, to said first and second positions.

3. A hologram viewing arrangement according to claim 1, wherein the pixels of the phase mask have substantially identical dimensions to the pixels of the hologram display substrate.

4. A hologram viewing arrangement according to claim 1, wherein the phase mask is a two level phase mask

5. A hologram viewing arrangement according to claim 4, constructed and arranged to operate at a given optical wavelength, wherein, with one of the levels of the phase mask as reference the other level provides a phase shift of substantially π to light at the given optical wavelength.

6. A hologram viewing arrangement according to claim 1, wherein the phase mask is a four level phase mask.

7. A hologram viewing arrangement according to claim 6, constructed and arranged to operate at a given optical wavelength, wherein taking one of the four phase mask levels as a reference, the remaining three provide phase shifts of respectively π/2, π and 3π/2 to light at the given optical wavelength.

8. A hologram viewing arrangement according to claim 1 wherein the hologram display substrate is arranged to display binary holograms.

9. A hologram viewing arrangement according to claim 1 wherein the phase mask has an equal number of mask pixels at each level.

10. A hologram viewing arrangement according to claim 1 wherein the phase mask is random.

11. A hologram viewing arrangement according to claim 1, wherein the phase mask has more than 4 levels.

12. A hologram viewing arrangement according to claim 1 wherein the hologram holds data on three or more images and wherein respective positions of the mask and display substrate allow each image to be displayed.

13. A hologram viewing arrangement according to claim 1 wherein said images are distinct, the arrangement being such that disposing the phase mask in a first position with respect to the display substrate enables only one of the at least two images to be visible and disposing the phase mask in a second position with respect to the display substrate enables only another of the at least two images to be visible.

14. An alignment device comprising a hologram viewing arrangement according to claim 1.

15. A display device comprising a hologram viewing arrangement according to claim 1.

16. A device for aligning first and second members comprising a hologram viewing arrangement according to claim 1, wherein one of the pixellated phase mask substrate and the pixellated hologram display substrate is secured to the first member and the other of the pixellated phase mask substrate and the pixellated hologram display substrate is secured to the second member.

17. A device for aligning an optical beam with a desired target comprising a hologram viewing arrangement according to claim 1, wherein one of the pixellated phase mask substrate and the pixellated hologram display substrate is disposed to receive the said optical beam, and the hologram composites together plural phase images each capable of deflecting an incident beam by a different angle, the device having means for translating the other of the pixellated phase mask substrate and the pixellated hologram display substrate with respect to the one of the pixellated phase mask substrate and the pixellated hologram display substrate so that an image is displayed such as to align the optical beam with the said target.

18. Measuring apparatus comprising a hologram viewing arrangement as claimed in claim 1.

19. A method of indicating displacement using a pixellated phase mask and a pixellated hologram, said hologram storing data representing at least two images such that disposing the phase mask in a first position with respect to the display substrate enables one of the at least two images to be visible and disposing the phase mask in a second position with respect to the display substrate enables another of the at least two images to be visible, the method comprising positioning said phase mask in conjunction with said hologram such that relative movement of said phase mask and said hologram displays said one or another of said images.

20. A hologram viewing arrangement comprising a pixellated phase mask substrate and a pixellated hologram display substrate, wherein the hologram display substrate is arranged to store data representing at least two images, the arrangement being such that disposing the phase mask in a first position with respect to the display substrate enables one of the at least two images to be visible and disposing the phase mask in a second position with respect to the display substrate enables another of the at least two images to be visible; wherein the pixellation axes of the two members are disposed mutually parallel and wherein one of the phase mask substrate and hologram display substrate is constructed and arranged to be subject to a translation with respect to the other of the two substrates parallel to a pixellation axis thereof, to said first and second positions; wherein said hologram is calculated to take into account said phase mask such that the hologram reconstructs at least two distinct images when optically combined with the phase mask, and wherein the arrangement is such that disposing the phase mask in a first position with respect to the display substrate enables only one of the at least two images to be visible and disposing the phase mask in a second position with respect to the display substrate enables only another of the at least two images to be visible.
